(19) United States
(12) Patent Application Publication
(10) Pub. No.: US 2026/0279003 A1
(43) Pub. Date: Sep. 17, 2026

(54) Systems and Methods for Inferring Biological, Environmental, Ecological, and Therapeutic States from Optical Interaction Dynamics and Multivariable Longitudinal Monitoring

(71) Applicant: Melinda Bernabe Chu, Blue Ash, OH (US)

(72) Inventor: Melinda Bernabe Chu, Blue Ash, OH (US)

(21) Appl. No.: 19/672,674

(22) Filed: May 10, 2026

Related U.S. Application Data
(60) Provisional application No. 63/772,536, filed on Mar. 15, 2025.
(60) Provisional application No. 63/907,142, filed on Oct. 29, 2025.
(60) Provisional application No. 63/922,137, filed on Nov. 21, 2025.
(60) Provisional application No. 63/930,716, filed on Dec. 4, 2025.

(51) Int. Cl. G06V 10/72; G06N 5/04; G06V 10/40

(52) U.S. Cl. CPC G06V 10/72; G06N 5/04; G06V 10/40

(57) ABSTRACT

Systems and methods are provided for inferring biological, environmental, ecological, therapeutic, industrial, agricultural, or physiologic states from optical interaction signatures and temporal optical interaction dynamics obtained through multivariable longitudinal monitoring. One or more imaging devices or sensors acquire optical interaction data associated with biological matrices, environmental samples, atmospheric systems, industrial processes, or other monitored environments. One or more processors extract quantitative optical interaction features—including Global Edge Coherence (GEC), Localized Edge Dynamics (LEDyn), speckle evolution, aggregation kinetics, and related metrics—and integrate these features with environmental variables, geospatial data, biologic measurements, therapeutic history, and longitudinal multimodal datasets using machine-learning and probabilistic inference engines. In certain embodiments, the system receives and processes structured Digital Twin Manifests (DTMs). The resulting probabilistic inferences support closed-loop adaptive monitoring, real-time therapeutic-response assessment, distributed smartphone-based environmental intelligence, environmental digital biomarkers, and proactive recommendations across laboratory, clinical, ecological, manufacturing, and extraterrestrial applications.

### CROSS-REFERENCE TO RELATED APPLICATIONS

This application claims the benefit of priority to, and incorporates by reference in their entirety, the disclosures of the following applications filed by the inventor:
U.S. Provisional Patent Application No. 63/772,536, filed Mar. 15, 2025, entitled “Systems and Methods for Detecting Microplastics and Nanoplastics in Intact Liquid Samples Using Adaptive Optical Interaction Metrics,” and related nonprovisional U.S. patent application Ser. No. 19/444,215;
U.S. Provisional Patent Application No. 63/907,142, filed Oct. 29, 2025, and related nonprovisional U.S. patent application Ser. No. 19/672,623, entitled “System and Method for Generating Reproducible Digital Twins of Assays”;
U.S. Provisional Patent Application No. 63/922,137, filed Nov. 21, 2025, and related nonprovisional U.S. patent application Ser. No. 19/672,559, entitled “Improving Analytical, Pharmaceutical, Nutritional, and Agricultural Reproducibility by Minimizing Shear-and Dissolution-Induced Variability Effects”;
U.S. Provisional Patent Application No. 63/930,716, filed Dec. 4, 2025, entitled “Systems and Methods for Closed-Loop Biological Fluid Monitoring of Therapeutic, Supplement, and Detoxification Responses Using Optical Signatures,” and related nonprovisional U.S. patent application Ser. No. 19/671,245; and
U.S. Provisional Patent Application No. 64/061,722, filed May 9, 2026, entitled “Systems and Methods for Inferring Biological, Environmental, Ecological, and Therapeutic States from Optical Interaction Dynamics and Multivariable Longitudinal Monitoring.”

### STATEMENT REGARDING FEDERALLY SPONSORED RESEARCH

No federal funding was used in the conception, development, or preparation of this invention.

This application further incorporates by reference related laboratory reports, technical papers, experimental datasets, figures, software architectures, optical interaction studies, longitudinal monitoring data, environmental monitoring data, and supporting research materials associated with the foregoing subject matter to the extent permitted by law.

### FIELD OF THE INVENTION

The present invention relates generally to computational inference systems, optical interaction analysis, biological and environmental monitoring, longitudinal data analysis, digital biomarker development, adaptive monitoring architectures, closed-loop feedback systems, environmental intelligence platforms, ecological-state estimation, and AI-enabled multivariable inference frameworks.

More specifically, the invention relates to systems and methods for inferring biological, environmental, ecological, therapeutic, industrial, agricultural, or physiologic states from optical interaction signatures, temporal optical dynamics, spatial pattern formation, environmental variables, and multimodal longitudinal datasets.

### BACKGROUND OF THE INVENTION

Traditional laboratory systems generally rely on direct analyte quantification, centralized laboratory testing, or isolated biomarker measurements to assess biological or environmental state.

However, many biologic and environmental systems are inherently multivariable, nonlinear, dynamic, and interaction-driven. In many contexts, isolated measurements provide limited insight into larger system-level states, longitudinal trends, or adaptive responses.

Recent advances in wearable sensing, distributed environmental monitoring, AI-based analytics, smartphone sensing, digital health systems, and environmental intelligence platforms have dramatically increased the quantity of available data. However, substantial challenges remain in interpreting such data within broader biologic, environmental, or ecological contexts.

Similarly, many environmental monitoring systems rely upon sparse, geographically limited, expensive, and infrequent centralized laboratory testing workflows, limiting the ability to identify dynamic environmental relationships, longitudinal exposure trends, or ecosystem-state changes.

The inventor recognized that optical interaction signatures, temporal interaction dynamics, environmental sensing variables, and distributed longitudinal monitoring data may collectively function as inferential proxies for broader biological, environmental, ecological, therapeutic, or physiologic states.

The inventor further recognized that high-frequency distributed sensing systems, including smartphone-enabled systems, may enable the discovery of previously unobservable relationships between environmental conditions, biological responses, ecosystem health, therapeutic response, and longitudinal state changes.

The inventor additionally recognized that these inferential capabilities can be integrated into closed-loop architectures that provide real-time or near-real-time adaptive feedback, therapeutic-response assessment, and intervention optimization.

The present invention addresses these limitations through systems and methods that integrate optical interaction signatures, environmental variables, temporal monitoring, geospatial sensing, machine-learning models, adaptive inference systems, and longitudinal datasets to generate probabilistic biological and environmental state estimations.

### SUMMARY OF THE INVENTION

The present invention provides systems and methods for inferring biological, environmental, ecological, therapeutic, physiologic, industrial, agricultural, or environmental states using optical interaction signatures, temporal optical dynamics, multivariable environmental data, and longitudinal monitoring systems.

In certain embodiments, optical interaction signatures derived from biological fluids, environmental liquids, industrial samples, ecological matrices, atmospheric systems, or other monitored systems are analyzed using computational models configured to infer broader system-level conditions.

The invention may utilize optical interaction signatures, temporal kinetic behavior, aggregation dynamics, weathering signatures, environmental variables, biological biomarkers, geospatial monitoring, distributed sensing systems, AI/ML inference engines, wearable-device integrations, longitudinal datasets, adaptive endpoints, and multimodal computational frameworks.

In certain embodiments, the invention may infer inflammatory burden, exposure burden, therapeutic response, environmental stress, ecosystem health, aquatic system stress, agricultural productivity, industrial process instability, biologic adaptation, ecological degradation, toxicologic burden, or longitudinal physiologic changes.

In some embodiments, optical interaction signatures associated with microplastics, nanoplastics, PFAS, heavy metals, surfactants, biologic aggregates, environmental contaminants, colloids, or particulate systems may contribute to larger probabilistic inference models.

The invention further contemplates integration with smartphone-based monitoring systems, distributed environmental sensing networks, cloud-based inference engines, geospatial intelligence systems, satellite systems, wearable devices, laboratory instrumentation, robotic laboratories, autonomous experimentation systems, and closed-loop adaptive monitoring architectures.

### DEFINITIONS

### Optical Interaction Signature

Any measurable optical, spatial, temporal, kinetic, spectral, aggregation-based, texture-based, brightness-based, scattering-based, refractive, or interaction-derived pattern associated with a monitored sample, system, fluid, environment, or biologic matrix.

### Optical Interaction Dynamics

The time-dependent evolution, kinetic behavior, or temporal changes observed in one or more optical interaction signatures, including but not limited to variations in Global Edge Coherence (GEC), Localized Edge Dynamics (LEDyn), radial gradient shifts (ΔRadial_Gradient), speckle evolution, aggregation kinetics, spatial redistribution patterns, and other measurable changes in optical, spatial, or textural features across sequential measurements or during the course of an assay.

### Biological State

Any physiologic, inflammatory, metabolic, immunologic, toxicologic, environmental-exposure, therapeutic-response, or biologic condition associated with a subject, population, organism, or biologic system.

### Environmental State

Any ecological, aquatic, atmospheric, geospatial, environmental-quality, contamination-related, agricultural, industrial, or ecosystem-level condition associated with an environmental system.

### Longitudinal Monitoring

Repeated measurements acquired across time to evaluate trends, trajectories, adaptation, progression, environmental change, therapeutic response, or probabilistic state evolution.

### Environmental Digital Biomarker

A computationally derived environmental indicator inferred from one or more optical, environmental, biological, geospatial, atmospheric, or chemical variables.

### BRIEF DESCRIPTION OF THE DRAWINGS

FIG. 1—System architecture for optical interaction-based biological and environmental inference.

FIG. 1—Representative system architecture illustrating AI-enabled biological and environmental inference from optical interaction signatures, longitudinal monitoring datasets, environmental variables, and distributed sensing systems. Smartphone-based and distributed sensing nodes acquire optical interaction data associated with biologic fluids, environmental samples, ecological systems, atmospheric systems, or industrial systems. Multi-modal datasets are processed by cloud-based computational inference engines configured to generate probabilistic biologic, environmental, ecological, therapeutic, or physiologic state estimations and adaptive monitoring recommendations.

FIG. 2—Representative longitudinal monitoring workflow using distributed smartphone-based sensing.

FIG. 2—Representative longitudinal monitoring workflow illustrating repeated acquisition of optical interaction measurements across distributed smartphone-enabled sensing systems. Longitudinal measurements are integrated with biologic variables, environmental variables, geospatial data, and temporal monitoring datasets to generate probabilistic biologic, environmental, therapeutic, or ecological state estimations and adaptive monitoring outputs over time.

FIG. 3—Correlation framework between optical interaction signatures and biologic or environmental variables

FIG. 3—Representative computational framework illustrating probabilistic relationships between optical interaction signatures and larger biologic, environmental, ecological, therapeutic, industrial, or physiologic variables. Optical interaction metrics including aggregation dynamics, radial redistribution behavior, texture patterns, scattering behavior, and temporal interaction dynamics are integrated with environmental and biologic variables to generate probabilistic state estimations and longitudinal inference models.

FIG. 4—AI/ML inference architecture integrating optical signatures, environmental variables, and longitudinal datasets.

FIG. 4—Representative artificial intelligence and machine-learning inference architecture integrating optical interaction signatures, environmental variables, biologic measurements, geospatial inputs, and longitudinal datasets into multimodal computational inference systems configured to generate probabilistic biologic, environmental, ecological, therapeutic, industrial, or physiologic state estimations

FIG. 5—Closed-loop adaptive monitoring and therapeutic-response framework.

FIG. 5—Representative closed-loop adaptive monitoring architecture configured to integrate optical interaction sensing, longitudinal monitoring, computational inference, therapeutic-response assessment, environmental intervention tracking, and adaptive recommendation generation into continuously updated biologic and environmental state-monitoring systems

FIG. 6—Geospatial environmental monitoring network utilizing distributed smartphone sensing systems.

FIG. 6—Representative distributed environmental monitoring network utilizing smartphone-enabled sensing systems and geospatial intelligence architectures to generate longitudinal environmental datasets, ecosystem-state maps, environmental burden distributions, and adaptive environmental monitoring outputs across geographically distributed regions

FIG. 7—Representative environmental inference framework integrating contaminant burden, ecological indicators, and temporal monitoring.

FIG. 7—Representative environmental and ecological inference framework integrating contaminant burden measurements, optical interaction dynamics, ecological indicators, environmental variables, and temporal monitoring datasets to generate probabilistic environmental-state estimations, ecosystem-stress assessments, and longitudinal environmental intelligence outputs

FIG. 8—Representative biologic inference framework integrating optical interaction metrics and inflammatory biomarkers.

FIG. 8—Representative biologic inference architecture integrating optical interaction signatures, biologic laboratory measurements, inflammatory biomarkers, longitudinal monitoring datasets, and probabilistic inference systems to generate biologic-state estimations, exposure-burden assessments, therapeutic-response monitoring outputs, and adaptive biologic monitoring trajectories

FIG. 9—Representative multimodal environmental-biological intelligence architecture.

FIG. 9—Representative multimodal intelligence architecture integrating biologic monitoring systems, environmental sensing systems, geospatial intelligence, longitudinal datasets, AI-enabled inference engines, and distributed sensing infrastructures into unified probabilistic environmental-biological monitoring and adaptive decision-support frameworks

FIG. 10—Representative extraterrestrial environmental inference and space-medicine monitoring embodiment.

FIG. 10—Representative extraterrestrial environmental and space-medicine monitoring embodiment integrating planetary environmental sensing, atmospheric optical monitoring, biologic monitoring, distributed sensing architectures, and AI-enabled probabilistic inference systems configured to evaluate habitat stability, astronaut physiologic status, environmental risk, and adaptive extraterrestrial operational conditions.

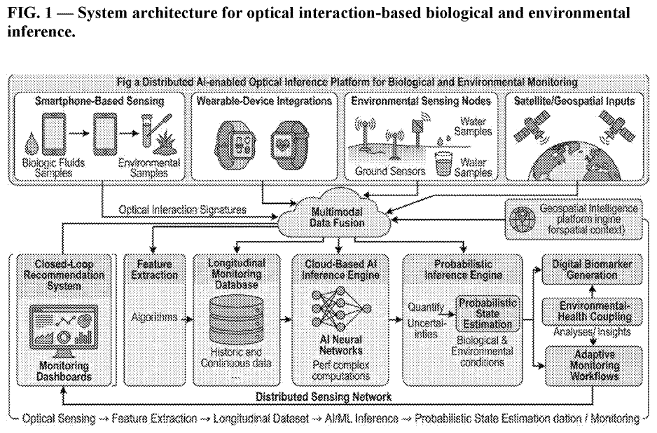

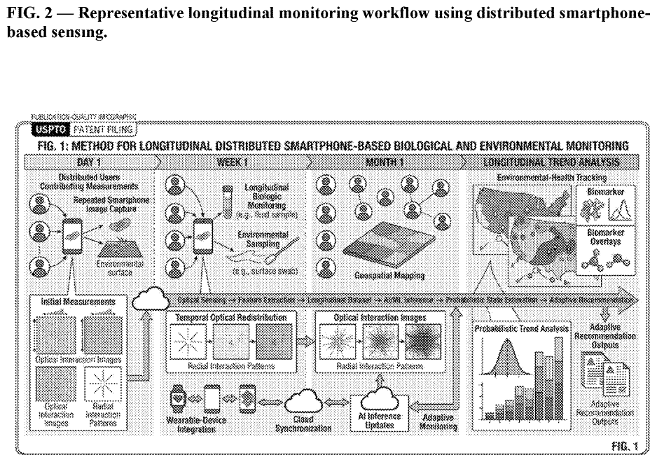

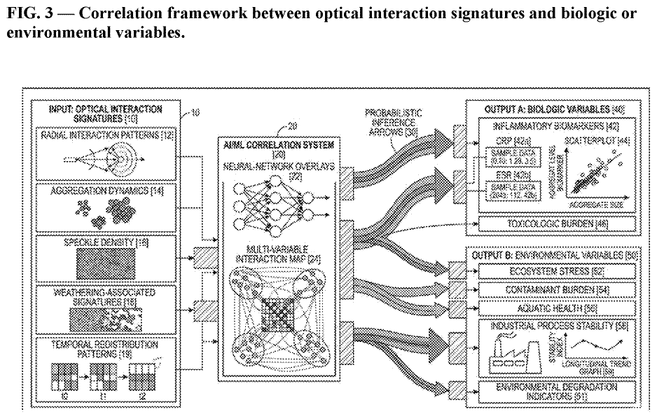

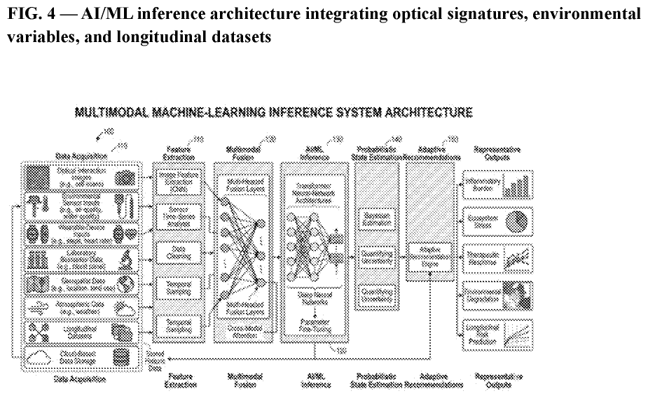

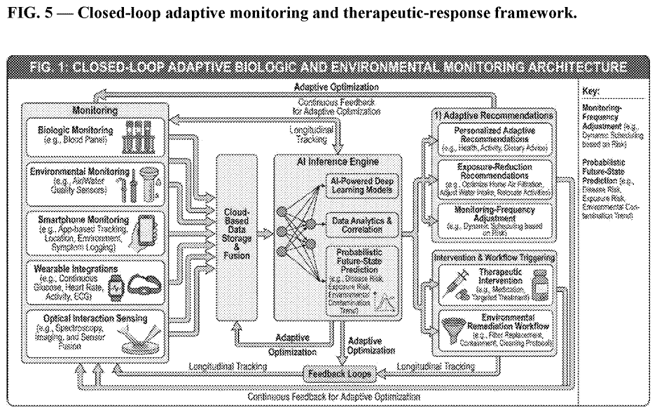

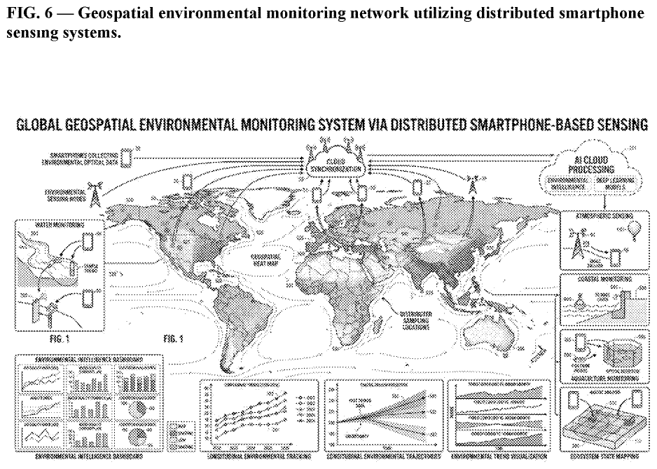

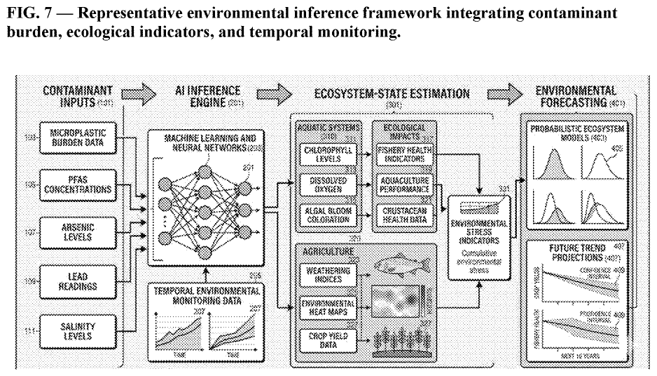

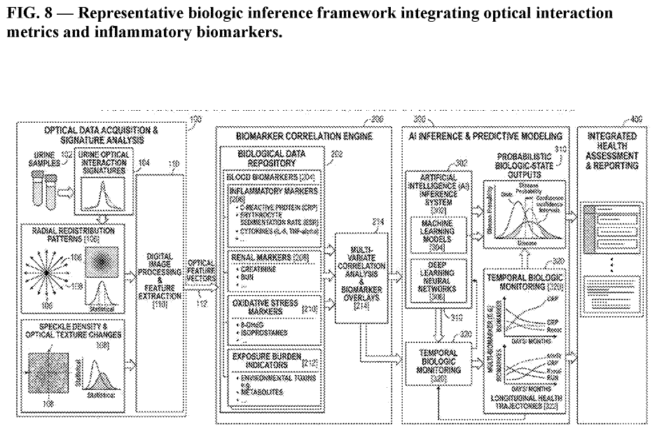

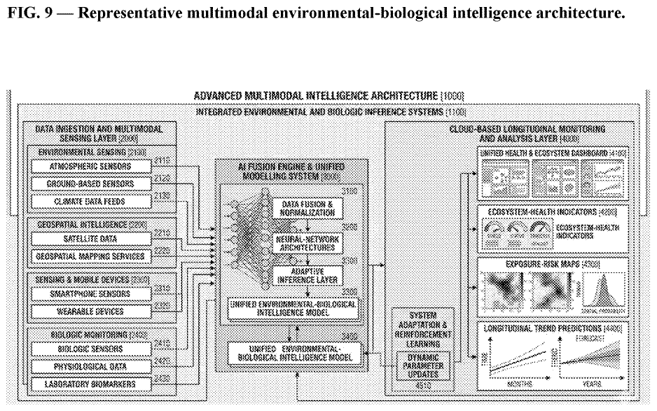

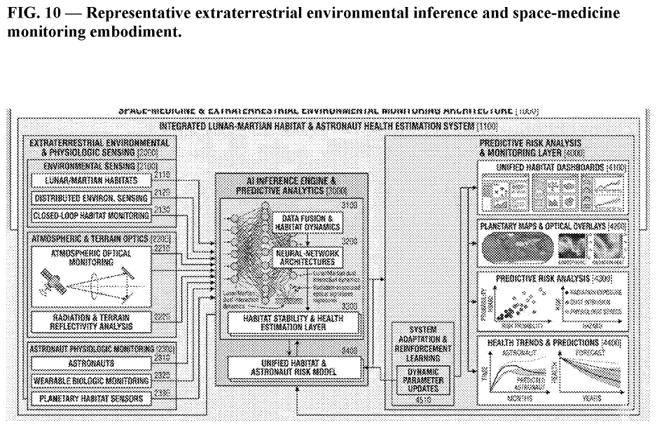

### DETAILED DESCRIPTION OF THE INVENTION

The present invention relates to systems and methods for inferring biological, environmental, ecological, therapeutic, physiologic, industrial, and agricultural conditions through the analysis of optical interaction signatures, temporal optical dynamics, multi-variable sensor data, and longitudinal monitoring. In various embodiments, optical interaction signatures obtained from biological fluids, environmental samples, industrial matrices, ecological systems, or atmospheric conditions are processed by advanced computational models to deduce higher-level system states.

The invention leverages a combination of optical interaction signatures, temporal and kinetic behaviors, aggregation and weathering patterns, environmental variables, biological biomarkers, geospatial and distributed sensing networks, AI and machine learning inference engines, wearable device integrations, longitudinal datasets, adaptive monitoring endpoints, and multimodal analytical frameworks.

In certain embodiments, the present system leverages the machine-readable Digital Twin Manifest (DTM) and Reproducibility Index (RI) generated by the system described in U.S. patent application Ser. No. 19/672,623. The structured, executable assay context contained in the DTM (including procedural graphs, environmental vectors, optical metrics such as GEC and LEDyn, and predicted vs. observed outcomes) serves as a rich, standardized multimodal input to the probabilistic inference engines described herein, enabling higher-order biological, environmental, and therapeutic state estimation.

In certain embodiments, the technology can infer inflammatory or toxicologic burden, exposure levels to environmental stressors, therapeutic efficacy and response, ecosystem or aquatic system health, agricultural productivity and stress, industrial process stability, biologic adaptation and resilience, ecological degradation trends, or long-term physiologic and environmental changes.

Optical signatures linked to microplastics, nanoplastics, PFAS, heavy metals, surfactants, biologic aggregates, colloids, and other particulate or contaminant systems can be incorporated into broader probabilistic inference models.

The invention further enables seamless integration with smartphone-based sensors, distributed environmental monitoring networks, cloud-based AI inference platforms, geospatial intelligence and satellite systems, wearable and laboratory instrumentation, robotic and autonomous experimentation platforms, and closed-loop adaptive control architectures.

### Biological Monitoring Embodiments

In certain embodiments, optical interaction signatures from urine, blood, saliva, sweat, wastewater, biologic fluids, or other matrices may be analyzed to infer inflammatory burden, exposure burden, oxidative stress, therapeutic response, biologic adaptation, metabolic trends, disease-associated states, or longitudinal physiologic trajectories.

In some embodiments, interaction signatures associated with microplastics or nanoplastics may correlate with inflammatory markers including CRP, ESR, cytokines, oxidative stress markers, renal markers, metabolic markers, or other biologic indicators.

In certain embodiments, the system may generate longitudinal biologic profiles using repeated measurements over time.

### Representative Experimental Data in Biological Matrices

In actual experiments conducted on Mar. 16-17, 2026, optical interaction signatures were evaluated in human urine samples (both filtered and unfiltered) using the Baobab assay system in a large-volume (~400 mL) optical setup. Nanoplastic-spiked samples (5 mL Stock A, ~100 nm spheres) produced early speckled optical heterogeneity at 15 minutes and pronounced radial redistribution with central clearing and peripheral concentration at 30 minutes. These structured spatial patterns were clearly distinguishable from baseline urine and from microplastic-spiked samples (~250 MP/L), which produced only minimal to moderate optical changes. Specifically, nanoplastic-spiked samples exhibited statistically significant increases in Global Edge Coherence (GEC) and Localized Edge Dynamics (LEDyn), along with elevated ΔRadial_Gradient values, compared to both baseline urine and microplastic controls.

Unfiltered urine exhibited higher baseline heterogeneity due to endogenous particulates and cellular debris, yet the nanoplastic-associated radial clearing, speckle evolution, and associated metric shifts remained clearly detectable. In contrast, filtered urine produced cleaner and more defined signatures while preserving the same core interaction dynamics. Cross-matrix comparisons showed that filtered urine behavior closely resembled that observed in salt-water systems once large debris was removed, indicating that ionic environment and particle-surface interactions dominate signal formation.

The subject's simultaneous blood chemistry panel showed normal renal function (BUN 11 mg/dL, creatinine 0.91 mg/dL), confirming that the observed optical patterns were particle-driven rather than artifacts of dehydration or renal pathology. These results demonstrate that the optical interaction features described herein—including GEC, LEDyn, ΔRadial_Gradient, speckle density, structured radial clearing, and related metrics—when processed through the Digital Twin infrastructure of related U.S. patent application Ser. No. 19/672,623, can serve as robust, real-time inferential proxies for nanoplastic exposure burden even in complex biological matrices.

### Environmental and Ecological Embodiments

In certain embodiments, environmental optical signatures, contaminant burdens, optical interaction dynamics, weathering patterns, or environmental variables may contribute to ecological or environmental-state inference systems.

Example variables may include: microplastic burden, nanoplastic burden, PFAS, arsenic, lead, turbidity, salinity, algal bloom coloration, dissolved oxygen, chlorophyll signatures, atmospheric conditions, industrial contamination, weathering indices, crustacean health, fish mortality, aquaculture performance, microbial dynamics, or crop-yield data.

In some embodiments, distributed smartphone-based sensing systems may generate dense geospatial datasets enabling longitudinal ecosystem-state analysis and environmental intelligence generation.

### Closed-Loop Therapeutic Embodiments

In certain embodiments, the system may integrate therapeutic-response monitoring, environmental exposure tracking, adaptive recommendations, and longitudinal biologic monitoring.

Optical interaction signatures may be used to evaluate:
therapeutic effectiveness,
remediation response,
environmental intervention outcomes,
nutritional interventions,
supplement response,
environmental exposure reduction,
or adaptive physiologic changes.

### Space Medicine and Planetary Monitoring Embodiments

In certain embodiments, environmental or optical variables associated with extraterrestrial environments may contribute to larger inference systems.

Example variables may include: atmospheric coloration, sky optical properties, dust signatures, solar interaction patterns, radiation-associated optical effects, terrain reflectivity, atmospheric particulate behavior, environmental interaction signatures, or planetary weather patterns.

Such variables may contribute to probabilistic inference systems associated with:
space medicine,
extraterrestrial environmental monitoring,
habitat stability,
planetary environmental risk,
infrastructure deployment,
astronaut health,
closed-loop habitat monitoring,
or commercial extraterrestrial operations.

In certain embodiments, distributed sensing architectures may be utilized in orbital, lunar, Martian, or other extraterrestrial environments.

### Artificial Intelligence, Computational/Digital Biomarker, and Predictive Inference Embodiments

In certain embodiments, the invention utilizes optical interaction signatures, environmental variables, biologic measurements, geospatial data, longitudinal monitoring datasets, or multimodal sensor inputs to generate computationally derived digital biomarkers representing probabilistic biological, environmental, ecological, industrial, agricultural, or therapeutic states.

In certain embodiments, the digital biomarkers may not directly measure a single analyte, but instead infer higher-order system states through pattern recognition, interaction dynamics, temporal behavior, environmental coupling, or multivariable inference architectures.

Example inferred biological or physiologic states may include:
(a) inflammatory burden,
(b) exposure burden,
(c) toxicologic burden,
(d) oxidative stress,
(e) therapeutic response,
(f)metabolic adaptation,
(g) hydration state,
(h) renal stress,
(i) environmental exposure trajectories,
(j) physiologic resilience,
(k) recovery dynamics,
(l) biologic aging patterns, and/or
(m) probabilistic disease-associated states.

Example environmental or ecological inference states may include:
(a) ecosystem stress,
(b) aquatic ecosystem instability,
(c) algal bloom progression,
(d) aquaculture performance,
(e) fishery stress,
(f) environmental degradation,
(g) contaminant burden,
(h) atmospheric instability,
(i) soil or agricultural stress,
(j) environmental toxicity trajectories,
(k) planetary environmental instability, and/or
(l) environmental-health coupling relationships.

In certain embodiments, longitudinal monitoring enables the system to identify:
(a) temporal trends,
(b) adaptive physiologic changes,
(c) chronic exposure trajectories,
(d) therapeutic-response evolution,
(e) environmental recovery patterns,
(f) ecosystem-state transitions,
(g) progressive biologic adaptation,
(h) probabilistic future-state predictions, and/or
(i) early warning signatures prior to overt system failure.

In certain embodiments, the invention integrates:
(a) optical interaction metrics,
(b) geospatial measurements,
(c) environmental sensor data,
(d) wearable-device data,
(e) biologic laboratory values,
(f) imaging features,
(g) weathering-associated variables,
(h) therapeutic intervention history,
(i) atmospheric variables,
(j) industrial process variables, and/or
(k) distributed smartphone-based sensing data into unified probabilistic inference frameworks.

In certain embodiments, machine-learning systems may identify correlations between optical interaction behavior and larger biologic or environmental states that are not directly observable through isolated analyte measurement alone.

For example, optical interaction signatures associated with particulate burden, aggregation dynamics, environmental weathering, or longitudinal interaction topology may correlate with:
(a) inflammatory biomarkers,
(b) environmental toxicity,
(c) ecosystem decline,
(d) therapeutic-response variability,
(e) industrial process instability,
(f) environmental exposure burden,
(g) Physiologic Stress, and/or
(h) adaptive biologic responses.

In certain embodiments, the system generates adaptive recommendations including:
(a) therapeutic recommendations,
(b) environmental remediation recommendations,
(c)monitoring-frequency adjustments,
(d) environmental intervention recommendations,
(e)manufacturing calibration recommendations,
(f) exposure-reduction recommendations,
(g) personalized longitudinal monitoring strategies, and/or
(h) Closed-loop Optimization Commands.

The invention further contemplates predictive inference systems configured to identify probabilistic future states before overt biologic, environmental, industrial, or ecosystem-level failure occurs.

In certain embodiments, distributed smartphone-enabled sensing architectures enable generation of dense longitudinal datasets that were previously impractical using sparse centralized laboratory workflows, thereby enabling discovery of new environmental-health relationships, longitudinal biologic trends, ecosystem-state dynamics, and adaptive interaction-driven behaviors.

### Concluding Statement

The present invention establishes a generalized computational and optical inference framework in which optical interaction signatures, environmental variables, biologic measurements, geospatial sensing, and longitudinal monitoring data may collectively contribute to probabilistic inference of larger biological, environmental, ecological, therapeutic, industrial, agricultural, or physiologic states.

The invention is not limited to any single analyte, biomarker, pollutant, biologic fluid, environmental matrix, optical metric, sensing modality, computational architecture, or application domain.

1. A system for inferring one or more biological, environmental, ecological, therapeutic, industrial, agricultural, or physiologic states, comprising:
(a) one or more imaging devices or sensors configured to acquire optical interaction data associated with a sample, biologic matrix, environmental matrix, atmospheric system, industrial system, or monitored environment;
(b) one or more processors configured to:
(i)process the optical interaction data,
(ii) generate one or more optical interaction features,
(iii) integrate the optical interaction features with one or more environmental,
biologic, temporal, geospatial, atmospheric, industrial, therapeutic, or longitudinal variables, and
(iv)generate one or more probabilistic state estimations of biological, environmental, ecological, therapeutic, industrial, agricultural, or physiologic conditions; and
(c) one or more memory devices configured to store longitudinal multimodal datasets associated with repeated measurements acquired across time.

2. The system of claim 1, wherein the probabilistic state estimations comprise:
(a) inflammatory burden,
(b) exposure burden,
(c) toxicologic burden,
(d) therapeutic response,
(e) environmental stress,
(f) ecosystem condition,
(g) agricultural productivity,
(h) industrial process instability,
(i) environmental degradation,
(j) physiologic adaptation, or
(k) longitudinal biologic-state trajectories.

3. The system of claim 1, wherein the optical interaction features comprise:
(a) aggregation dynamics,
(b) radial interaction patterns,
(c) temporal redistribution behavior,
(d) scattering behavior, (e) texture-based metrics,
(f) brightness gradients,
(g) refractive interaction features,
(h) weathering-associated signatures,
(i) GEC metrics,
(j) LEDyn metrics,
(k) Z-density metrics, or
(l) combinations thereof.

4. The system of claim 1, wherein the biologic matrix comprises urine, blood, saliva, sweat, wastewater, lymphatic fluid, interstitial fluid, cerebrospinal fluid, or combinations thereof.

5. The system of claim 1, wherein the environmental variables comprise one or more of:
(a)microplastic burden,
(b) nanoplastic burden,
(c) PFAS burden,
(d) arsenic concentration,
(e) lead concentration,
(f) turbidity,
(g) salinity,
(h) chlorophyll signals,
(i) dissolved oxygen,
(j) algal bloom coloration,
(k) atmospheric conditions,
(l)weathering indices, or
(m) environmental contaminant burden.

6. The system of claim 1, wherein the one or more processors utilize a machine-learning architecture, probabilistic inference engine, neural network, digital twin architecture, adaptive inference engine, or multimodal AI framework.

7. The system of claim 1 or claim 6, wherein the one or more processors are further configured to receive and process a Digital Twin Manifest (DTM) generated according to the system of U.S. patent application Ser. No. 19/672,623.

8. The system of claim 1, further comprising a distributed sensing architecture configured to receive optical interaction measurements from one or more smartphone-based sensing systems across geographically distributed locations.

9. The system of claim 8, further comprising a geospatial environmental intelligence platform configured to generate longitudinal environmental-state maps from distributed optical interaction measurements.

10. The system of claim 1, further comprising a closed-loop recommendation engine configured to:
(a) generate therapeutic recommendations,
(b) generate environmental remediation recommendations,
(c) modify monitoring frequency,
(d) generate exposure-reduction recommendations, or
(e) generate adaptive monitoring recommendations.

11. A method for inferring one or more biological, environmental, ecological, therapeutic, industrial, agricultural, or physiologic states, comprising:
(a) acquiring optical interaction data from one or more monitored systems;
(b) extracting one or more optical interaction features from the acquired data;
(c) integrating the optical interaction features with one or more environmental, biologic, geospatial, temporal, atmospheric, industrial, therapeutic, or longitudinal variables;
(d) generating one or more longitudinal multimodal datasets; and
(e) applying one or more computational inference models to generate one or more probabilistic state estimations.

12. The method of claim 11, wherein repeated optical interaction measurements are utilized to identify:
(a) longitudinal biologic trends,
(b) therapeutic-response trajectories,
(c) ecosystem-state evolution,
(d) environmental recovery patterns,
(e) chronic exposure trajectories, or
(f) probabilistic future-state changes.

13. The method of claim 11, wherein the probabilistic state estimations are generated prior to overt biologic, environmental, industrial, or ecosystem-level failure.

14. A non-transitory computer-readable medium storing instructions that, when executed by one or more processors, cause the processors to:
(a) receive optical interaction data;
(b) generate optical interaction features;
(c) integrate multimodal environmental, biologic, geospatial, temporal, or longitudinal variables;
(d) generate probabilistic state estimations; and
€ output one or more biologic, environmental, therapeutic, ecological, industrial, or physiologic inferences.

15. The system of claim 1, wherein the system further integrates wearable-device data, laboratory biomarker data, atmospheric variables, industrial process variables, therapeutic intervention history, or satellite-derived environmental measurements.

16. The system of claim 1, wherein the probabilistic inference comprises an environmental digital biomarker, optical biomarker, ecosystem-state indicator, environmental-health coupling metric, or longitudinal exposure-risk score.
